(19) United States
(12) Patent Application Publication
(10) Pub. No.: US 2024/0347265 A1
(43) Pub. Date: Oct. 17, 2024

(54) COIL COMPONENT

(71) Applicant: SAMSUNG ELECTRO-MECHANICS CO., LTD., Suwon-si (KR)

(72) Inventors: Soon Kwang Kwon, Suwon-si (KR); Tae Hyun Kim, Suwon-si (KR); Dong Hwan Lee, Suwon-si (KR); Byeong Cheol Moon, Suwon-si (KR); Boum Seock Kim, Suwon-si (KR)

(73) Assignee: SAMSUNG ELECTRO-MECHANICS CO., LTD., Suwon-si (KR)

(21) Appl. No.: 18/583,238

(22) Filed: Feb. 21, 2024

(30) Foreign Application Priority Data
Apr. 17, 2023 (KR) 10-2023-0049952

(51) Int. Cl. H01F 27/32; H01F 27/30

(52) U.S. Cl. CPC H01F 27/324; H01F 27/306

(57) ABSTRACT

A coil component includes a body, a coil disposed within the body, a first insulating film covering a surface of the coil, where the first insulating film includes a first inorganic compound, and a second insulating film covering a surface of the first insulating film, where the second insulating film includes a second inorganic compound, wherein at least one of the first inorganic compound and the second inorganic compound include metal nitride.

### CROSS-REFERENCE TO RELATED APPLICATION(S)

This application claims benefit of priority to Korean Patent Application No. 10-2023-0049952 filed on Apr. 17, 2023 in the Korean Intellectual Property Office, the disclosure of which is incorporated herein by reference in its entirety.

### TECHNICAL FIELD

The present disclosure relates to a coil component.

With a reduction in size and thickness of electronic devices such as digital TVs, mobile phones, laptops, and the like, it has been required for coil components applied to the electronic to have a reduced size and thickness. Research and development of various winding types or thin film types of coil components have been actively conducted to satisfy such requirements.

As coil components have a reduced size and thickness, an improvement in heat dissipation properties of electronic components has become an important issue. This is because saturation current properties and high-current efficiency of inductors decrease with an increase in temperature of electronic components.

In the related art, parylene may be generally used as a magnetic material in a body and an insulating material of a coil, but parylene has a thermal conductivity of 0.10 W/mK, making it difficult to dissipate heat from the inside of a coil component to the outside of the coil component.

### SUMMARY

An aspect of the present disclosure provides a coil component having improved high-current efficiency by improving heat dissipation properties.

According to an aspect of the present disclosure, there is provided a coil component including a body, a coil disposed within the body, a first insulating film covering a surface of the coil, where the first insulating film includes a first inorganic compound, and a second insulating film covering a surface of the first insulating film, where the second insulating film includes a second inorganic compound, wherein at least one of the first inorganic compound and the second inorganic compound include metal nitride.

According to example embodiments of the present disclosure, a coil component may have increased heat dissipation efficiency, thereby improving high-current efficiency properties.

### BRIEF DESCRIPTION OF DRAWINGS

The above and other aspects, features, and advantages of the present disclosure will be more clearly understood from the following detailed description, taken in conjunction with the accompanying drawings, in which:

FIG. 1 is a schematic perspective view of a coil component according to a first example embodiment of the present disclosure;

FIG. 2 is a schematic cross-sectional view of a coil component taken along line I-I′ in FIG. 1;

FIG. 3 is an enlarged view of region A in FIG. 2;

FIG. 4 is a schematic enlarged view of a coil component according to a second example embodiment; and

FIG. 5 is a schematic enlarged view of a coil component according to a third example embodiment.

### DETAILED DESCRIPTION

Hereinafter, terminology used herein is for the purpose of describing particular example embodiments only and is not to be limiting of the example embodiments. As used herein, the singular forms “a,” “an,” and “the” are intended to include the plural forms as well, unless the context clearly indicates otherwise. As used herein, the term “and/or” includes any one and any combination of any two or more of the associated listed items. It will be further understood that the terms “comprises” and/or “comprising,” when used in this specification, specify the presence of stated features, integers, steps, operations, elements, components or a combination thereof, but do not preclude the presence or addition of one or more other features, integers, steps, operations, elements, components, and/or groups thereof. In addition, the terms “disposed on,” “positioned on,” and the like, may mean the element is positioned on or below a target portion, and does not necessarily mean that the element is positioned on an upper side of the target portion with respect to a direction of gravity.

The terms “coupled to,” “connected to,” and the like, may not only indicate that elements are directly and physically in contact with each other, but also include a configuration in which another element is interposed between the elements such that the elements are also in contact with the other element.

The size and thickness of each element illustrated in the drawings is arbitrarily represented for ease of the description, but the present disclosure is not necessarily limited to those illustrated herein.

In the drawings, an X-direction may be defined as a first direction or an L direction, a Y-direction may be defined as a second direction or a W direction, and a Z-direction may be defined as a third direction or a T direction.

Hereinafter, a coil component according to an example embodiment of the present disclosure will be described in detail with reference to the accompanying drawings. In the description with reference to the accompanying drawings, the same or corresponding elements are denoted by the same reference numerals and repeated descriptions thereof will be omitted.

Various types of electronic components may be used in electronic devices, and various types of coil components may be appropriately used between such electronic components to remove noise.

That is, in an electronic device, a coil component may be used as a power inductor, a high frequency (HF) inductor, a general bead, a high-frequency bead (GHz bead), a common mode filter, and the like.

Hereinafter, a coil component according to the present disclosure will be described. The coil component will be described using a structure of an inductor as an example for ease. However, as described above, the coil component according to the present example embodiment may be applied to coil components for various other purposes.

### First Example Embodiment

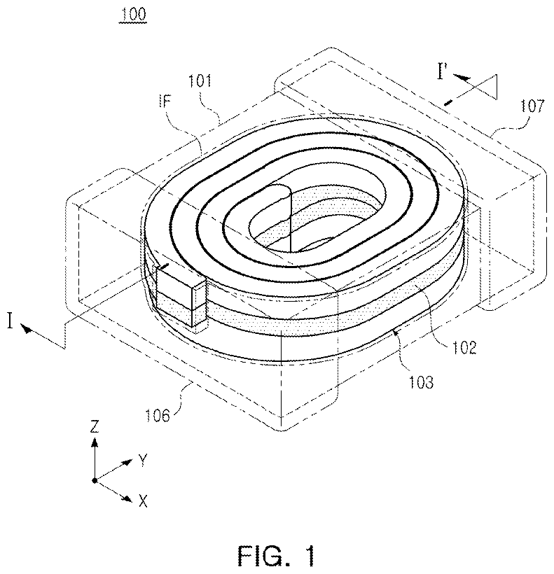

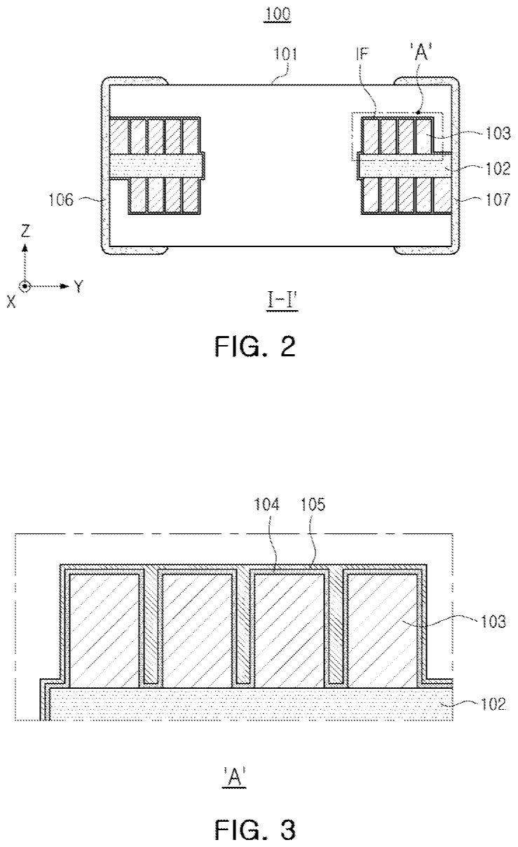

FIG. 1 is a schematic perspective view of a coil component 100 according to a first example embodiment of the present disclosure. FIG. 2 is a schematic cross-sectional view of a coil component taken along line I-I′ of FIG. 1. FIG. 3 is an enlarged view of region A of FIG. 2.

With respect to that illustrated in FIG. 1, in the following description, a first direction may be defined as an X-direction, a second direction may be defined as a Y-direction, and a third direction may be defined as a Z-direction.

Referring to FIG. 1, the coil component 100 according to an example embodiment of the present disclosure may include a body 101, a coil 103, and an insulating film IF. The coil 103 may be buried within the body 101. In this case, a support member 102, supporting the coil 103, may be disposed within the body 101.

The body 101 may form the exterior of the coil component 100, and may have a substantially hexahedral shape having first and second surfaces opposing each other in the first direction (X-direction), third and fourth surfaces opposing each other in the second direction (Y-direction), and fifth and sixth surfaces opposing each other in the third direction (Z-direction), but the present disclosure is not limited thereto.

The body 101 may include a magnetic material. The magnetic material may include, without limitation, any material having magnetic properties, and may be formed by, for example, filling ferrite or a metallic soft magnetic material. The ferrite may include known ferrite such as Mn—Zn-based ferrite, Ni—Zn-based ferrite, Ni—Zn—Cu-based ferrite, Mn—Mg-based ferrite, Ba-based ferrite, or Li-based ferrite. The metallic soft magnetic material may be an alloy including at least one selected from the group consisting of Fe, Si, Cr, Al, and Ni, and may include, for example, Fe—Si—B—Cr amorphous metal particles, but the present disclosure is not limited thereto. The metallic soft magnetic material may have a particle size of 0.1 μm or more and 20 μm or less, and may be included in the form of being dispersed on a polymer such as an epoxy resin or polyimide.

The support member 102 may be configured to support the coil 103 to be described below.

The support member 102 may be formed of an insulating material including a thermosetting insulating resin such as an epoxy resin, a thermoplastic insulating resin such as polyimide, or a photosensitive insulating resin, or an insulating material in which a reinforcing material such as a glass fiber or an inorganic filler is impregnated with the above-described insulating resin. For example, the support member 102 may be formed of an insulating material such as a prepreg, an Ajinomoto build-up film (ABF), FR-4, a bismaleimide triazine (BT) film, a photoimageable dielectric (PID) film, or the like, but the present disclosure is not limited thereto.

The inorganic filler may be at least one selected from the group consisting of silica (SiO₂), alumina (Al₂O₃), silicon carbide (Sic), barium sulfate (BaSO₄), talc, mud, mica powder, aluminum hydroxide (Al(OH)₃), magnesium hydroxide (Mg(OH)₂), calcium carbonate (CaCO₃), magnesium carbonate (MgCO₃), magnesium oxide (MgO), boron nitride (BN), aluminum borate (AlBO₃), barium titanate (BaTio₃), and calcium zirconate (CaZrO₃).

When the support member 102 is formed of an insulating material including a reinforcing material, the support member 102 may have more excellent rigidity. When the support member 102 is formed of an insulating material including no glass fiber, it may be advantageous in reducing a thickness of the entire coil 103. When the support member 102 is formed of an insulating material including a photosensitive insulating resin, the number of processes of forming the coil 103 may be reduced. Thus, it may be advantageous in reducing production costs, and a fine via may be formed.

The coil 103 may perform various functions within an electronic device through the properties expressed by a coil of a coil component 100. For example, when the coil component 100 may be a power inductor. In this case, the coil 103 may serve to stabilize power of the electronic device by storing electricity in the form of a magnetic field and maintaining an output voltage. In this case, the coil 103 may be formed on at least one surface of the support member 102. An outermost portion of the coil 103 may have a lead-out end exposed to the outside of the body 101 for electrical connection with external electrodes 106 and 107.

The coil 103 may form a plurality of turns with respect to a central axis substantially, parallel to the third direction, and the plurality of turns may be formed using a plating process used in the art, for example, a method such as pattern plating, anisotropic plating, isotropic plating, or the like, and may also have a multilayer structure using a plurality of processes, among the above-described processes.

FIG. 2 is a schematic cross-sectional view of a coil component taken along line I-I′ of FIG. 1.

The insulating film IF may be disposed between the coil 103 and the body 101 to cover the coil 103. The insulating film IF may be formed along surfaces of the support member 102 and the coil 103. The insulating film IF may be used to insulate the coil 103 from the body 101, and may be formed by a method such as vapor deposition, but the present disclosure is not limited thereto. The insulating film IF may be formed by laminating an insulating film on both surfaces of the support member 102.

In the related art, parylene may be generally used as a magnetic material in a body and an insulating material of a coil. However, it may be difficult to dissipate heat from the inside of a coil component to the outside of the coil component. Accordingly, with an increase in temperature of the coil component, the magnetic material may have reduced magnetization (Ms), and the coil component may have degraded saturation current (Isat) properties and reduced high-current efficiency.

In order to address such issues, in the present disclosure, a structure may be designed to secure insulating properties between a coil and a magnetic material of a body and to facilitate heat transfer from the inside of a coil component to the outside of the coil component, thereby securing high-current efficiency of the coil component.

In the present disclosure, a single insulating film, including parylene having low thermal conductivity, may be formed to increase heat dissipation efficiency of the coil component 100. In this case, the insulating film IF, including a material having high thermal conductivity, may be doubly disposed on a surface of the coil 103. Specifically, the present disclosure may include a first insulating film 104, covering the surface of the coil 103, and a second insulating film 105, covering a surface of the first insulating film, and the first and second insulating films 104 and 105 may include an inorganic compound. At least one of the first inorganic compound and the second inorganic compound may include metal nitride.

FIG. 3 is an enlarged view of region A of FIG. 2.

Referring to FIG. 3, the first insulating film 104 may cover the surface of the coil 103, and may basically serve to protect the coil 103. In addition, the first insulating film 104 may serve to insulate between the coil 103 and a magnetic material of the body 101 and to dissipate heat generated in the coil component 100.

The first insulating film 104 may include an inorganic compound, and specifically may include metal oxide or metal nitride.

Referring to FIG. 3, the second insulating film 105 may cover a surface of the first insulating film 104, and may basically serve to protect the first insulating film 104. In addition, the second insulating film 105 may serve to insulate between the coil 103 and a magnetic material of the body 101 while protecting the first insulating film 104, and to dissipate heat generated in the coil component 100.

The second insulating film 105 may include an inorganic compound, and may specifically include metal nitride or metal oxide.

That is, a double insulating film may be disposed on the coil 103, and may be disposed in the order of metal oxide-metal nitride or metal nitride-metal oxide.

The metal nitride and the metal oxide may be a material having thermal conductivity higher than that of parylene. In this case, a double insulating film, including a material having thermal conductivity higher than that of parylene, may be formed, thereby facilitating heat transfer between the coils 103 through the insulating films 104 and 105.

The metal nitride may be a material having thermal conductivity higher than that of the metal oxide.

The metal oxide may be a material having resistivity higher than that of parylene, and the metal nitride may be a material having resistivity lower than that of parylene. an insulating film may be formed of the metal oxide having resistivity higher than that of parylene, thereby securing the same level of insulating properties with a smaller volume, as compared to a case in which parylene is used as the insulating material. Accordingly, an insulating film thickness (insulating thickness) may be reduced relative to an insulating effect the same as that of parylene, and heat transfer through the insulating films 104 and 105 may be facilitated as the insulating thickness decreases.

The metal nitride may include at least one nitride selected from the group consisting of aluminum (Al) nitride, silicon (Si) nitride, titanium (Ti) nitride, vanadium (V) nitride, and chromium (Cr) nitride. More specifically, the metal nitride may be aluminum nitride (AlN), but the present disclosure is not limited thereto. Any material, having thermal conductivity higher than that of parylene and resistivity lower than that of parylene, may be sufficient.

The metal oxide may include at least one oxide selected from the group consisting of aluminum (Al) oxide, beryllium (Be) oxide, magnesium (Mg) oxide, titanium (Ti) oxide, and zinc (Zn) oxide. More specifically, the metal oxide may be alumina (Al₂O₃), but the present disclosure is not limited thereto. Any material, having thermal conductivity higher than that of parylene and resistivity higher than that of parylene, may be sufficient.

A method of measuring or detecting an inorganic compound included in the first insulating film 104 and the second insulating film 105 may be performed by, for example, scanning, with a scanning electron microscope (SEM), a cross-section of the first insulating film 104 or the second insulating film 105 in second and third directions and then analyzing the scanned cross-section using energy dispersive spectroscopy (EDS). Thermal conductivity and resistivity, intrinsic properties of a material, may be identified by analyzing a composition of the insulating film based on results of the measurement. The thermal conductivity and resistivity of the insulating film and parylene may be measured at the same temperature.

At least one of the first insulating film 104, the second insulating film 105, or a portion of the body 101 may be disposed between turns, adjacent to each other, among the plurality of turns of the coil 103.

Specifically, referring to FIG. 3, only the first insulating film 104 and the second insulating film 105 may be disposed between turns, adjacent to each other, among the plurality of turns of the coil 103. A magnetic material of the body 101 may not be disposed in a space between turns, adjacent to each other, among the plurality of turns of the coil 103, but only the first insulating film 104 and the second insulating film 105, including a material having high thermal conductivity, may be disposed. Accordingly, heat dissipation through the insulating film may more efficiently occur.

Referring to FIG. 3, in a cross-section, parallel to the third direction, a cross-sectional area of the second insulating layer may be larger than a cross-sectional area of the first insulating layer.

A method of measuring a cross-sectional area of the insulating film IF will be described in detail below.

As illustrated in FIG. 2, with respect to a cross-section (Y-Z cross-section) in the second direction (Y-direction)-the third direction (Z-direction) of a central portion of the coil component 100 in the first direction (X-direction), the cross-sectional areas of the first insulating film 104 and the second insulating film 105 may be measured.

In this case, the measured cross-sectional area of the second insulating film 105 may be larger than the cross-sectional area of the first insulating film 104. Here, the cross-sectional areas of the first insulating film 104 and the second insulating film 105 may respectively refer to dimensions of the first insulating film 104 and the second insulating film 105 in the second direction (Y-direction)-the third direction (Z-direction).

Each of the dimensions may refer to a value obtained by performing measurement once or an arithmetic average of values obtained by performing measurement multiple times in the same region. Alternatively, each of the dimensions may refer to an arithmetic average of values obtained by performing measurement once in each of a plurality of regions or an arithmetic average of values obtained by performing measurements multiple times in each of the plurality of regions.

The external electrodes 106 and 107 may be formed on the outside of the body 101 and connected to the coil 103. Specifically, the external electrodes 106 and 107 may be connected to a lead-out end of the coil 103. The external electrodes 106 and 107 may be formed using a paste including a metal having excellent electrical conductivity, for example, a conductive paste including nickel (Ni), copper (Cu), tin (Sn), or silver (Ag) alone or alloys thereof. In addition, a plating layer may be further formed on the external electrodes 106 and 107. In this case, the plating layer may include at least one selected from the group consisting of nickel (Ni), copper (Cu), and tin (Sn). For example, a nickel (Ni) layer and a tin (Sn) layer may be sequentially formed.

### Second Example Embodiment

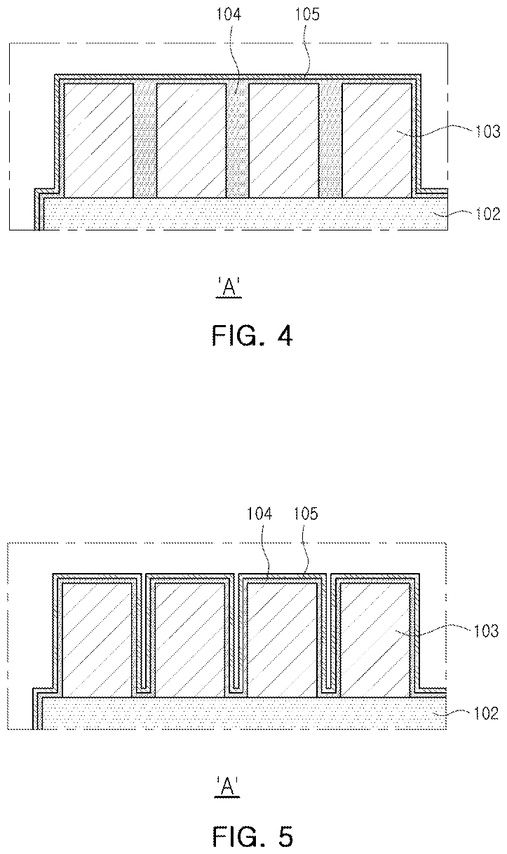

FIG. 4 is a schematic enlarged view of a coil component according to a second example embodiment, and FIG. 4 is an enlarged view corresponding to region A of FIG. 2, but differences between the second example embodiment and the first example embodiment will be described in detail below.

Referring to FIG. 4, only one of the first and second insulating films 104 and 105 may be disposed between turns, adjacent to each other, among a plurality of turns.

That is, as compared to the first example embodiment, a second insulating film 105 may not be disposed between turns, adjacent to each other, among a plurality of turns of a coil 103, and only the first insulating film 104 may be disposed between the turns.

Other contents may be substantially the same as those described in the first example embodiment, and thus detailed descriptions are omitted.

### Third Example Embodiment

FIG. 5 is a schematic enlarged view of a coil component according to a third example embodiment. FIG. 5 is an enlarged view corresponding to region A of FIG. 2, but differences between the third example embodiment and the first example embodiment will be described in detail below.

Referring to FIG. 5, a first insulating film 104 and a second insulating film 105 may be disposed between turns, adjacent to each other, among a plurality of turns of a coil 103, and a portion of a body 101 may be disposed between the second insulating films 105, adjacent to each other.

As compared to the first and second example embodiments, an excellent heat dissipation effect may be secured while minimizing a volume of an insulating material.

Other contents may be substantially the same as those described in the first example embodiment, and thus detailed descriptions are omitted.

While example embodiments have been shown and described above, it will be apparent to those skilled in the art that modifications and variations could be made without departing from the scope of the present disclosure as defined by the appended claims.

What is claimed is:

1. A coil component comprising:
a body;
a coil disposed within the body;
a first insulating film covering a surface of the coil, wherein the first insulating film includes a first inorganic compound; and
a second insulating film covering a surface of the first insulating film, wherein the second insulating film include a second inorganic compound,
wherein at least one of the first inorganic compound and the second inorganic compound include metal nitride.

2. The coil component of claim 1, wherein
the first inorganic compound includes metal oxide, and
the second inorganic compound includes metal nitride.

3. The coil component of claim 1, wherein
the first inorganic compound includes metal nitride, and
the second inorganic compound includes metal oxide.

4. The coil component of claim 2, wherein the metal nitride and the metal oxide are materials having thermal conductivity higher than that of parylene.

5. The coil component of claim 4, wherein the metal nitride is a material having a thermal conductivity higher than that of the metal oxide.

6. The coil component of claim 2, wherein
the metal oxide is a material having resistivity higher than that of parylene, and
the metal nitride is a material having resistivity lower than that of parylene.

7. The coil component of claim 2, wherein
the metal nitride includes at least one nitride selected from the group consisting of aluminum (Al) nitride, silicon (Si) nitride, titanium (Ti) nitride, vanadium (V) nitride, and chromium (Cr) nitride, and
the metal oxide includes at least one oxide selected from the group consisting of aluminum (Al) oxide, beryllium (Be) oxide, magnesium (Mg) oxide, titanium (Ti) oxide, and zinc (Zn) oxide.

8. The coil component of claim 1, wherein the coil includes a plurality of turns with respect to a central axis, substantially parallel to a third direction.

9. The coil component of claim 8, wherein at least one of the first insulating film, the second insulating film, or a portion of the body is disposed between adjacent turns among the plurality of turns.

10. The coil component of claim 9, wherein only one of the first and second insulating films is disposed between the adjacent turns.

11. The coil component of claim 9, wherein only the first insulating film and the second insulating film are disposed between the adjacent turns.

12. The coil component of claim 11, wherein, in a cross-section parallel to the third direction, a cross-sectional area of the second insulating film is larger than a cross-sectional area of the first insulating film.

13. The coil component of claim 1, further comprising:
a support member disposed within the body,
wherein the coil is disposed on at least one surface of the support member.

14. The coil component of claim 3, wherein the metal nitride and the metal oxide are materials having thermal conductivity higher than that of parylene.

15. The coil component of claim 14, wherein the metal nitride is a material having a thermal conductivity higher than that of the metal oxide.

16. The coil component of claim 3, wherein
the metal oxide is a material having resistivity higher than that of parylene, and
the metal nitride is a material having resistivity lower than that of parylene.

17. The coil component of claim 3, wherein
the metal nitride includes at least one nitride selected from the group consisting of aluminum (Al) nitride, silicon (Si) nitride, titanium (Ti) nitride, vanadium (V) nitride, and chromium (Cr) nitride, and
the metal oxide includes at least one oxide selected from the group consisting of aluminum (Al) oxide, beryllium (Be) oxide, magnesium (Mg) oxide, titanium (Ti) oxide, and zinc (Zn) oxide.

18. The coil component of claim 2, wherein
the metal nitride includes aluminum (Al) nitride, and
the metal oxide includes aluminum (Al) oxide.

19. The coil component of claim 3, wherein
the metal nitride includes aluminum (Al) nitride, and
the metal oxide includes aluminum (Al) oxide.
